(19) United States
(12) Patent Application Publication
(10) Pub. No.: US 2026/0195526 A1
(43) Pub. Date: Jul. 9, 2026

(54) APPLYING TRANSFORMATIONS TO AI-GENERATED CONTENT BASED ON VISUAL ANNOTATION INTERPRETATION

(71) Applicant: International Business Machines Corporation, Armonk, NY (US)

(72) Inventors: Al Chakra, Apex, NC (US); Nathan Montgomery Gurley, Maineville, OH (US); Xiao Xia Mao, Shanghai (CN); Shi Hui Gui, Shanghai (CN)

(21) Appl. No.: 19/010,291

(22) Filed: Jan. 6, 2025

(51) Int. Cl. G06F 40/169; G06F 40/205; G06F 40/47

(52) U.S. Cl. CPC G06F 40/169; G06F 40/205; G06F 40/47

(57) ABSTRACT

Examples herein describe transforming generative AI content using visual annotations. The process begins with receiving a user prompt for the AI system to generate a content item which is then displayed to the user. Users apply annotations to the content, creating an annotated version. The system parses the annotated version to identify each annotation's type and location, translating the annotations into text-based calls for the AI to process. These calls are sequentially provided to the AI which generates responses. The system consolidates these responses into a revised content item that reflects the user's annotations and displays the final version to the user.

### BACKGROUND

The discourse generally relates to artificial intelligence (AI) technologies and more specifically to applying transformations to generative AI content based on visual annotation interpretation.

The recent surge in advanced computational technologies has led to an innovative approach in various industries including content creation, marketing, and education. One notable application of these technologies is the use of text-based prompts for revising generated text. This method allows users to provide specific instructions or edits to computational models, resulting in more accurate and tailored outputs.

There are some limitations to consider when using text-based prompts for revising generated content. If there is a lengthy document or if there are multiple iterations, the process takes time to add all the comments for revision. Additionally, people with limited vocabulary or a low education background cannot write effective prompts. The feedback mechanism provided in existing tools evaluates the piece of content generated, but it lacks a mechanism that could provide accurate feedback, training, and fine-tuning.

### SUMMARY

According to one aspect of the present invention, a computer-implemented method for applying transformations to generative AI content based on visual annotation interpretation is provided. The method includes receiving a prompt from a user for a generative AI system to create a content item, providing the prompt to the generative AI system for processing, receiving the content item from the generative AI system, and displaying the content item to the user. The method also includes receiving a plurality of annotations applied by the user to the content item to create an annotated content item, parsing the annotated content item to identify a type and a location of each of the plurality of annotations, translating each of the plurality of annotations into a corresponding text-based call that the generative AI system can interpret, sequentially providing the text-based calls to the generative AI system for processing, receiving and consolidating responses from the generative AI system to create a revised content item, wherein the revised content item reflects the transformations indicated by the annotations, and displaying the revised content item to the user.

Various features and advantages of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment according to one or more embodiments;

FIG. 2 illustrates a block diagram of a system for applying transformations to generative AI content based on visual annotation interpretation according to one or more embodiments;

FIG. 3 illustrates an annotation panel for use in applying transformations to generative AI content based on visual annotation interpretation according to one or more embodiments;

FIGS. 4A and 4B illustrate a user interface for interacting with a generative AI model according to one or more embodiments; and

FIG. 5 illustrates a flow chart diagram of a method for applying transformations to generative AI content based on visual annotation interpretation according to one or more embodiments.

The detailed description explains embodiments of the disclosure, together with advantages and features, by way of example with reference to the drawings.

### DETAILED DESCRIPTION

The recent surge in generative artificial intelligence (AI) has led to innovative approaches in various industries including content creation, marketing, and education. One notable application of this technology is the use of text-based prompts for revising generated text. This method allows users to provide specific instructions or edits to the AI model, resulting in more accurate and tailored outputs.

However, there are some limitations to consider when using text-based prompts for revising generated content. If there is a lengthy document or if there are multiple iterations, the process takes time to add all the comments for revision. Additionally, people with limited vocabulary or a low education background cannot write effective prompts. The feedback mechanism provided in existing tools evaluates the piece of content generated, but it lacks a micro-management or evaluation mechanism necessary for more accurate feedback, training, and fine-tuning.

In exemplary embodiments, a method of applying multiple and granular style transformations to AI-generated content based on visual annotation interpretation is provided. The method allows users to use individually-defined visual annotations to the generative AI system. These visual annotations can be used to indicate the user's feedback or request on a granular portion of the generative AI-created output. Multiple visual annotations can be widely used in a large language model (LLM)-generated output to indicate multiple comments. The individually defined visual annotations can be learned and interpreted as text-based calls; the visual annotations can be shaped into a sequence of calls to the generative AI system. Each call is automatically run against the generative AI system one by one and then displayed to the user after the sequence is exhausted to make the output appear as if all annotations were completed as one batch job. The individually defined visual annotations can be provided by any users who cannot or do not want to type or spell the text-based prompts, thus saving the language learning and prompt engineering efforts.

Descriptions of various embodiments of the present disclosure are presented for purposes of illustration. The disclosure is not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

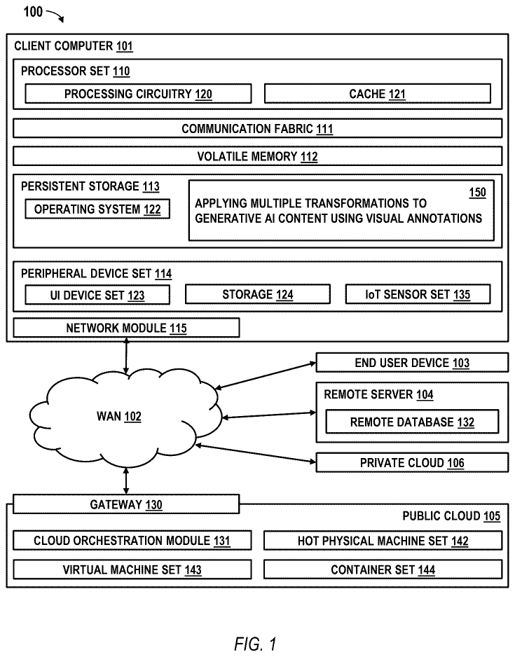

FIG. 1 illustrates a computing environment 100, according to an embodiment. Computing environment 100 contains an example of an environment for the execution of at least some of the computer code involved in applying multiple transformations to generative AI content using visual annotations 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

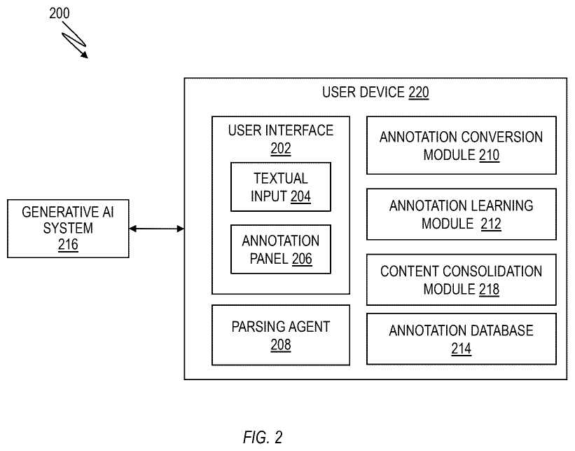

Referring now to FIG. 2, a block diagram of a system 200 for assessing applying transformations to generative AI content based on visual annotation interpretation is provided. The system 200 includes a generative AI system 216 that is configured to communicate with a user device 220. In exemplary embodiments, the user device 220 serves as the interface through which users interact with the generative AI system 216. The user device 220 may be a computer, such as the client computer 101 shown in FIG. 1, a smartphone, a tablet, or the like. The generative AI system 216 may be one of a wide variety of types of generative AI systems. For instance, the generative AI system 216 may be a Large Language Model (LLM) that performs natural language processing to enable users to generate text, answer questions, and engage in conversations. In another example, the generative AI system may generate images from textual descriptions, allowing artists and designers to explore new creative possibilities. Additionally, the generative AI system may generate videos and animations.

In exemplary embodiments, the user device 220 serves as the interface through which users interact with the generative AI system 216. The user interface 202 provides a graphical interface for users to interact with the system. The user interface 202 includes various elements such as text input fields, annotation tools, and display areas for the generated content. The user interface 202 enables users to input a textual input 204 and apply visual annotations through the annotation panel 206. The textual input 204 receives the initial content, also referred to herein as a prompt, provided by the user. This content serves as the base material that the generative AI system 216 will process and transform based on the visual annotations applied by the user. The annotation panel 206 is a dedicated section within the user interface 202 where users can select and apply visual annotations to the content generated by the generative AI system 216. The annotation panel 206 includes various types of annotations such as emojis, icons, and other visual markers that represent different style transformations or feedback.

In exemplary embodiments, the parsing agent 208 is responsible for analyzing the visual annotations provided by the user and identifying the position of the applied visual annotations. The parsing agent 208 ensures that each annotation is accurately mapped to the corresponding portion of the text. In exemplary embodiments, the parsing agent 208 is configured to scan the entire content item to detect the presence of any visual annotations such as emojis, icons, or other visual markers. Once these annotations are identified, the parsing agent 208 determines their exact locations within the content item, ensuring that each annotation is precisely mapped to the corresponding portion of the content. This involves not only pinpointing the specific words or sentences associated with each annotation but also understanding the broader context in which the annotation is applied. By doing so, the parsing agent 208 ensures that the intended feedback or style transformation is correctly interpreted and applied to the relevant sections of the text. This mapping process provides the foundation for converting visual annotations into actionable text-based instructions that the generative AI system 216 can execute.

In exemplary embodiments, the annotation conversion module 210 converts the visual annotations into text-based calls that the generative AI system 216 can interpret. The annotation conversion module 210 translates each visual annotation into a specific instruction or set of instructions that guide the transformation of the content. In exemplary embodiments, the annotation conversion module 210 performs the conversion of visual annotations into text-based calls through a series of steps.

First, the module identifies and recognizes the visual annotations applied by the user; the visual annotations may include emojis, icons, or other visual markers representing different style transformations or feedback. Once the visual annotations are recognized, the annotation conversion module 210 conducts a contextual analysis to understand the meaning and intent behind each annotation. This involves analyzing the surrounding text and the specific location of the annotation to determine the appropriate transformation or feedback.

Next, the annotation conversion module 210 maps each visual annotation to a corresponding text-based instruction or set of instructions. For example, a “confused” emoji might be mapped to an instruction like “clarify this section” and a “heart” icon could be mapped to “add a positive tone.” This mapping is based on predefined rules and learned patterns from historical data.

After mapping the visual annotations to text-based instructions, the module generates the specific instructions that will guide the transformation of the content. These instructions are formulated in a way that the generative AI system 216 can interpret and execute. The annotation conversion module 210 then sequences the generated instructions in the order they should be executed and prioritizes them based on their importance and the overall context of the content. This ensures that the most critical transformations are applied first.

Finally, the annotation conversion module 210 communicates the text-based instructions to the generative AI system 216. The generative AI system 216 processes these instructions to transform the content accordingly. The result is a revised output that reflects the user's feedback and style preferences. By following these steps, the annotation conversion module 210 effectively translates visual annotations into actionable text-based calls, enabling the generative AI system 216 to apply precise and contextually relevant transformations to the content.

In exemplary embodiments, the annotation learning module 212 is configured to learn and interpret the individually defined visual annotations over time. The annotation learning module 212 uses machine learning techniques to understand the meanings and contexts of various visual annotations; using these machine learning techniques improves the accuracy and relevance of the transformations. The annotation learning module 212 is designed to learn and interpret individually defined visual annotations over time, enhancing the system's ability to accurately and contextually transform content. This module employs machine learning techniques to understand the meanings and contexts of various visual annotations.

Initially, the annotation learning module 212 collects data on the visual annotations applied by users along with the corresponding text-based instructions and the resulting transformations. By analyzing this historical data, the module identifies patterns and correlations between specific visual annotations and their intended meanings or transformations. Over time, the module refines its understanding through continuous learning, adapting to new annotations, and evolving user preferences. This iterative learning process allows the annotation learning module 212 to improve the accuracy and relevance of the transformations applied by the generative AI system 216. As a result, the system becomes more adept at interpreting user-provided visual annotations, ensuring that the generated content aligns closely with the user's feedback and style preferences.

In exemplary embodiments, the content consolidation module 218 consolidates the transformed content after the generative AI system 216 processes the sequence of text-based calls generated by the annotation conversion module 210. The content consolidation module 218 ensures that the final output appears as if all annotations were completed as one batch job. After the generative AI system 216 processes the sequence of text-based calls generated by the annotation conversion module 210, the content consolidation module 218 consolidates these transformations into a cohesive final output. This involves aggregating the individual changes made to various portions of the content and ensuring that they are harmoniously integrated. The module reviews the transformed sections to ensure consistency and coherence, making it appear as if all annotations were completed as one batch job. By doing so, the content consolidation module 218 eliminates any disjointedness that might arise from processing multiple annotations separately, providing a polished and unified final output that accurately reflects the user's feedback and style preferences.

In exemplary embodiments, the annotation database 214 stores the visual annotations and their corresponding text-based calls. The annotation database 214 maintains a repository of annotations, allowing the system to reference and reuse them for future transformations. The annotation database 214 stores custom mappings between visual annotations and their corresponding text-based calls. When a user applies a visual annotation, such as an emoji or icon, to a content item, the system needs to translate this visual marker into a specific instruction that the generative AI system can interpret. The annotation database 214 maintains a comprehensive mapping of these visual annotations to their respective text-based prompts. For example, a “confused” emoji might be mapped to a text prompt like “clarify this section” and a “heart” icon could be mapped to “add a positive tone.” These mappings are based on predefined rules and learned patterns from historical data, ensuring that the system can accurately interpret and apply the user's feedback.

Additionally, the annotation database 214 can store other sets of visual annotations including regional annotations, corporate annotations, industrial annotations, and emotional annotations. For example, regional annotations may be visual markers that reflect cultural nuances, local slang, or region-specific symbols. For instance, a maple leaf icon may indicate Canadian content or style whereas a kangaroo icon may signify Australian vernacular. The annotation database 214 may store these regional annotations to ensure that the content aligns with local contexts.

Corporate annotations may be annotations that align with a company's branding, guidelines, or internal communication standards. Examples may include a company logo icon to indicate sections that should follow corporate branding guidelines or a compliance checkmark to signify regulatory standards. Storing these annotations may help maintain consistency with corporate policies.

Industrial annotations may be visual markers specific to certain industries or professional fields. For example, a beaker icon may be used for scientific content or a wrench icon may be used for technical instructions. The database may store these annotations to tailor the content to meet industry-specific standards or jargon.

Emotional annotations may be used to convey specific emotions or tones. For example, a heart icon may be used to add a positive tone or a sad face emoji may be used to indicate sympathy. Storing these annotations may help adjust the sentiment or emotional impact of the content.

In exemplary embodiments, the annotation database 214 may also support the learning process of the annotation learning module 212 by providing historical data on annotations and their interpretations. In one example, this process begins with the collection and storage of data on all visual annotations applied by users along with the corresponding text-based instructions and the resulting transformations. This data includes information about the type of annotation, its location within the content, the context in which it was used, and the specific text-based call it was mapped to. The annotation learning module 212 accesses this historical data to analyze patterns and correlations between specific visual annotations and their intended meanings or transformations. By examining past instances where certain annotations were used, the module can identify common trends and relationships.

Using machine learning techniques, the annotation learning module 212 processes the historical data to recognize patterns in how visual annotations are interpreted and applied. For example, it may learn that a “confused” emoji is frequently used to request clarification in technical documents and a “heart” icon is often used to add a positive tone in personal communications. The historical data serves as a training dataset for the machine learning models within the annotation learning module 212. By training on this data, a model can improve its ability to accurately interpret new visual annotations based on learned patterns and contextual information.

The annotation learning module 212 may continuously update its models by incorporating new data from the annotation database 214. As users apply more visual annotations and the system processes more transformations, the database grows, providing an ever-expanding dataset for the learning module. This continuous learning process may enable the system to adapt to evolving user preferences and new types of annotations. Additionally, the system can implement a feedback loop where the results of the transformations are evaluated, and any discrepancies or inaccuracies may be fed back into the annotation database 214. This feedback helps refine the mappings and improve the accuracy of future interpretations.

By leveraging the historical data stored in the annotation database 214, the annotation learning module 212 can enhance its understanding of visual annotations, leading to more accurate and contextually relevant transformations. This iterative learning process ensures that the generative AI system becomes increasingly adept at interpreting user-provided visual annotations, resulting in content that closely aligns with the user's feedback and style preferences.

In exemplary embodiments, the system 200 encompasses all the aforementioned components working together to enable the application of multiple and granular-style transformations to AI-generated content based on visual annotation interpretation. The system 200 integrates the user device 220, user interface 202, textual input 204, annotation panel 206, parsing agent 208, annotation conversion module 210, annotation learning module 212, content consolidation module 218, and annotation database 214 to provide a comprehensive solution for efficient and accurate content transformation.

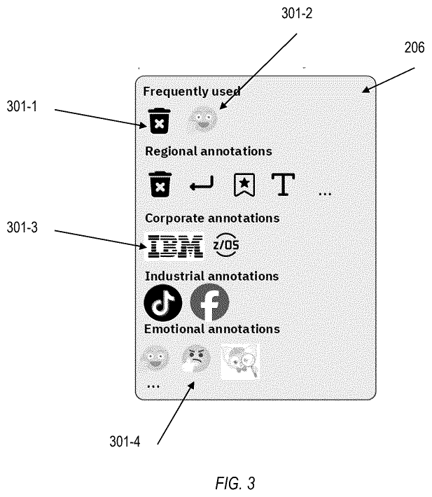

Referring now to FIG. 3, an annotation panel 206 for use in applying transformations to generative AI content based on visual annotation interpretation is shown. The annotation panel 206 includes various types of annotations such as the first annotation 301-1, the second annotation 301-2, the third annotation 301-3, and the fourth annotation 301-4, which are referred to collectively herein as annotations 301. In exemplary embodiments, the annotations 301 are displayed in groups such as frequently used annotations, regional annotations, corporate annotations, industrial annotations, and emotional annotations.

In exemplary embodiments, regional annotations are visual markers commonly understood within a specific geographic area, reflecting cultural nuances, local slang, or region-specific symbols. For instance, a maple leaf icon can indicate Canadian content or style, a kangaroo icon can signify Australian vernacular or references, and a traditional Japanese cherry blossom can denote a Japanese cultural context.

In exemplary embodiments, corporate annotations align with a company's branding, guidelines, or internal communication standards, ensuring that the content adheres to corporate policies and styles. Examples include a company logo icon to indicate sections that should follow corporate branding guidelines, a compliance checkmark to signify that the content needs to meet regulatory or compliance standards, and an internal memo icon to denote content that should be formatted according to internal communication templates.

In exemplary embodiments, industrial annotations are specific to certain industries or professional fields, helping tailor the content to meet industry-specific standards or jargon. Examples include a beaker icon for scientific or laboratory-related content, a wrench icon to indicate technical or engineering-related instructions, and a stethoscope icon for medical or healthcare-related content.

In exemplary embodiments, emotional annotations convey specific emotions or tones, helping adjust the sentiment or emotional impact of the content. Examples include a heart icon to add a positive or affectionate tone, a sad face emoji to indicate that a section should convey sympathy or sadness, a confused emoji to suggest that the content should be clarified, and a laughing emoji to suggest that the content should be humorous or light-hearted.

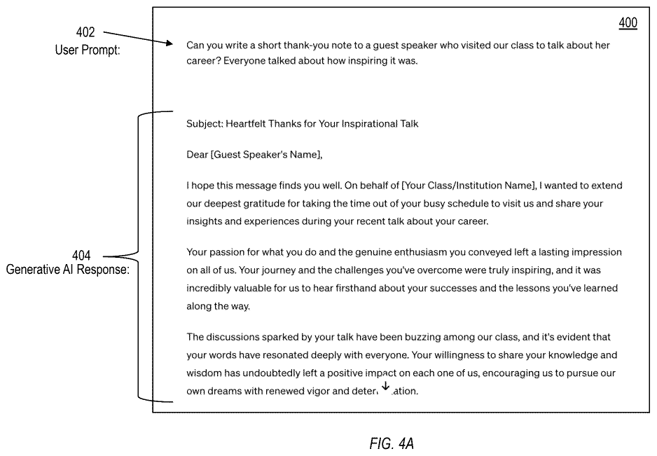

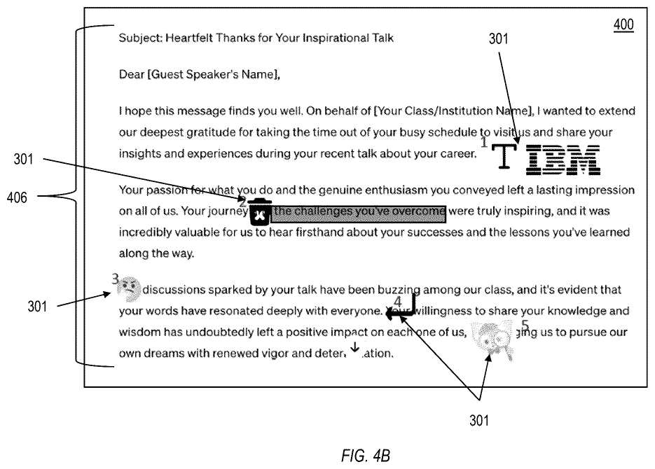

Referring now to FIGS. 4A and 4B, a display 400 illustrating a user interface for interacting with a generative AI system is shown. The display 400 includes a user prompt 402 and a content item 404 that was generated by the AI system in response to the user prompt 402. The user prompt 402 is the initial input provided by the user to the generative AI system. In the illustrated example, the user prompt 402 requests the AI system to write a short thank-you note to a guest speaker who visited a class to talk about her career. The user prompt 402 serves as the base material that the AI system processes to generate the content item 404. The content item 404 is the output generated by the AI system in response to the user prompt 402. The content item 404 includes a subject line and a body of text that forms the thank-you note. The content item 404 reflects the AI system's interpretation and transformation of the user prompt 402 into a coherent and contextually appropriate response.

In exemplary embodiments, after the content item 404 is displayed to the user via the display 400, a user may utilize the annotation panel to annotate the content item 404 to create an annotated content item 406. For example, the user may drag and drop visual annotations 301 onto the content item to create the annotated content item 406. The visual annotations 301 are various types of visual markers applied to the annotated content item 406. These annotations represent different style transformations or feedback provided by the user. The visual annotations 301 can include emojis, icons, and other visual markers that indicate the user's desired changes to the content. The visual annotations 301 are interpreted by the system to apply the corresponding transformations to the annotated content item 406.

In some embodiments, after the content item 404 is displayed to the user via the display 400, a user may utilize a voice command system to annotate the content item 404 to create an annotated content item 406. For example, the user may speak specific instructions such as “highlight the second paragraph and add a confused emoji” or “delete the last sentence and add a heart icon at the end of the first paragraph.” The voice command system interprets these spoken instructions and applies the corresponding visual annotations 301 onto the content item, creating the annotated content item 406. This method provides an alternative to a drag-and-drop approach, allowing users to interact with the system hands-free and potentially increasing accessibility for users with physical limitations or those who prefer voice interaction.

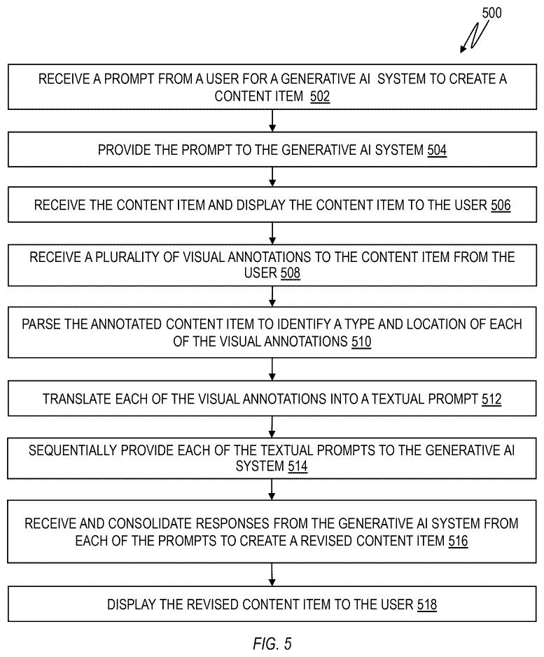

Referring now to FIG. 5, a flow chart diagram of a method 500 for applying transformations to generative AI content based on visual annotation interpretation according to one or more embodiments is shown. In exemplary embodiments, the method 500 may be performed by the system 200 shown in FIG. 2. The method 500 begins at block 502 by receiving a prompt from a user for a generative AI system to create a content item. For example, a user might input a prompt asking the generative AI system to write a thank-you note, to request the system to generate a summary of a research paper, or to generate a presentation or other media item. Next, as shown at block 504, the method 500 includes providing the prompt to the generative AI system for processing. Once the generative AI system generates the content item, it is displayed to the user, as shown at block 506. For instance, the thank-you note, or the research paper summary is shown on the user's screen.

Next, as shown at block 508, the method 500 includes receiving a plurality of visual annotations to the content item from the user. For example, the user might drag and drop a heart emoji onto the thank-you note to add a positive tone or place a confused emoji on a section of the research paper summary that needs clarification. The method 500 also includes parsing the annotated content item to identify the type and location of each visual annotation as shown at block 510. For example, the system may identify the heart emoji and its location within the thank-you note or detect the confused emoji and its position in the research paper summary.

The method 500 also includes translating each visual annotation into a textual prompt, as shown at block 512. For example, the heart emoji might be translated into a prompt instructing the AI to add a positive tone to the specified section whereas the confused emoji could be converted into a prompt asking the AI to clarify the marked section. Next, as shown at block 514, these textual prompts are sequentially provided to the generative AI system. For example, the system sends the positive tone prompt to the generative AI model for the thank-you note and submits the clarification prompt for the research paper summary.

The method 500 also includes receiving and consolidating responses from the generative AI system from each of the prompts to create a revised content item as shown at block 516. For instance, the generative AI system may process a positive tone prompt and return the revised thank-you note which is then consolidated into a single document. Similarly, the system may address the clarification prompt and provide the updated research paper summary, integrating it into a cohesive document. Once all of the responses to the prompts have been received and consolidated, the method 500 includes displaying the revised content item to the user, as shown at block 518.

In exemplary embodiments, processing multiple prompts, consolidating the responses, and displaying a single revised content item offer several significant benefits. First, it enhances efficiency by reducing the iterative back-and-forth process typically required when making multiple revisions. Instead of addressing each change individually, users can provide a comprehensive set of visual annotations at once; the system may process the entire comprehensive set in a single batch. This streamlined approach saves time and effort, allowing users to achieve their desired output more quickly.

Second, consolidating the responses ensures consistency and coherence in the final content. By aggregating the individual changes into a unified document, the system reduces the disjointedness that might arise from processing multiple annotations separately. This results in a polished and cohesive final output that accurately reflects the user's feedback and style preferences.

Additionally, processing multiple prompts, consolidating the responses, and displaying a single revised content item improves the accuracy of the transformations. By processing all annotations together, the system can better understand the overall context and relationships between different parts of the content. This holistic view allows for more precise and contextually relevant transformations, ensuring that the final content aligns closely with the user's intent.

Finally, displaying a single revised content item enhances user experience by providing a clear and comprehensive view of the final output. Users can easily review the entire document in one go, making it simpler to verify that all requested changes have been correctly implemented. This approach reduces the cognitive load on users, making the revision process more intuitive and user-friendly.

In exemplary embodiments, using visual annotations rather than textual annotations offers several key benefits. First, visual annotations significantly enhance the efficiency and speed of the feedback process. Users can quickly drag and drop visual markers, such as emojis or icons, onto the content rather than typing out detailed textual instructions. This reduces the time and effort required to provide feedback, especially for lengthy documents or complex revisions.

Second, visual annotations are more intuitive and accessible, particularly for users with limited vocabulary or lower educational backgrounds. Visual markers can straightforwardly convey complex instructions or emotions, making it easier for all users to interact with the system. This inclusivity ensures that a broader range of users can effectively utilize the generative AI system without needing advanced language skills.

In addition, visual annotations can provide more precise and contextually relevant feedback. By placing visual markers directly on the specific sections of the content that need revision, users can indicate the exact location and nature of the desired changes. This direct mapping reduces the risk of misinterpretation and ensures that the generative AI system applies the transformations accurately.

Moreover, visual annotations can enhance the user experience by making the feedback process more engaging and less cumbersome. The use of familiar icons and emojis can make the interaction with the system more enjoyable and less formal, encouraging users to provide more detailed and thoughtful feedback.

Finally, visual annotations can be standardized and customized to suit different user groups, industries, or regions. This flexibility allows for the creation of a tailored annotation system that meets the specific needs and preferences of various users, further improving the accuracy and relevance of the content transformations.

In an exemplary embodiment, the AI-generated content is a video, and the user can pause the video and place visual annotations on different locations within the displayed frame. This embodiment enhances the user's ability to provide detailed and context-specific feedback on video content generated by the AI system. When the user pauses the video, the current frame is displayed on the screen, allowing the user to interact with it. The user can then select visual annotations, such as emojis, icons, or other visual markers, from an annotation panel and place them in specific locations within the paused frame. For example, the user might place a “thumbs up” icon on a particular scene to indicate approval or a “confused” emoji on a section that needs clarification.

In this embodiment, the parsing agent 208 is configured to identify the video frame and the location of the annotation on the frame. The parsing agent 208 first captures the timestamp of the paused video frame, ensuring that the exact moment in the video is recorded. This timestamp serves as a reference point for the annotation

Next, the parsing agent 208 determines the precise location of the visual annotation within the frame. This involves mapping the coordinates of the annotation to the corresponding area of the video frame. Once the timestamp and location of the annotation are identified, the parsing agent 208 ensures that each annotation is accurately mapped to the corresponding portion of the video content. This meticulous mapping process is essential for converting visual annotations into actionable text-based instructions that the generative AI system can execute. For instance, a “confused” emoji placed on a specific timestamp and location might be translated into a prompt instructing the AI to clarify the content at that particular moment in the video.

After the annotations are mapped and translated into text-based calls, the generative AI system processes these instructions to transform the video content accordingly. The system might add explanatory text, adjust the visual effects, or make other modifications based on the user's feedback. The revised video is then consolidated and displayed to the user, reflecting the transformations indicated by the visual annotations. This embodiment allows users to provide granular and contextually relevant feedback on AI-generated video content, enhancing the accuracy and relevance of the transformations applied by the generative AI system. By enabling users to pause the video and place visual annotations on specific frames, the system ensures that the feedback is precise and directly applicable to the relevant sections of the video.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for applying transformations to generative AI content based on visual annotation interpretation, the method comprising:
receiving a prompt from a user for a generative AI system to create a content item;
providing the prompt to the generative AI system for processing;
receiving the content item from the generative AI system;
displaying the content item to the user;
receiving a plurality of annotations applied by the user to the content item to create an annotated content item;
parsing the annotated content item to identify a type and a location of each of the plurality of annotations;
translating each of the plurality of annotations into a corresponding text-based call that the generative AI system can interpret;
sequentially providing the text-based calls to the generative AI system for processing;
receiving and consolidating responses from the generative AI system to create a revised content item, wherein the revised content item reflects the transformations indicated by the annotations; and
displaying the revised content item to the user.

2. The computer-implemented method of claim 1, wherein the annotations represent different feedback and at least one of the plurality of annotations is a visual annotation.

3. The computer-implemented method of claim 2, wherein the visual annotation comprises one of emojis, icons, and other visual markers.

4. The computer-implemented method of claim 2, wherein the visual annotation is an individually defined visual annotation.

5. The computer-implemented method of claim 4, further comprising learning and interpreting the individually defined visual annotations over time using machine learning techniques.

6. The computer-implemented method of claim 1, further comprising displaying an annotation panel to select and apply annotations to the content item.

7. The computer-implemented method of claim 1, wherein the annotations are applied to specific sections of the content item to indicate an exact location and nature of a desired change.

8. The computer-implemented method of claim 1, wherein the annotations are converted into text-based calls through a contextual analysis of a surrounding text and the location of the annotation.

9. The computer-implemented method of claim 1, wherein at least two or more of the plurality of annotations are received simultaneously.

10. A system comprising:
a memory comprising computer readable instructions; and
a processing device for executing the computer readable instructions, the computer readable instructions controlling the processing device to perform operations comprising:
receiving a prompt from a user for a generative AI system to create a content item;
providing the prompt to the generative AI system for processing;
receiving the content item from the generative AI system;
displaying the content item to the user;
receiving a plurality of annotations applied by the user to the content item to create an annotated content item;
parsing the annotated content item to identify a type and a location of each of the plurality of annotations;
translating each of the plurality of annotations into a corresponding text-based call that the generative AI system can interpret;
sequentially providing the text-based calls to the generative AI system for processing;
receiving and consolidating responses from the generative AI system to create a revised content item, wherein the revised content item reflects transformations indicated by the annotations; and
displaying the revised content item to the user.

11. The system of claim 10, wherein the annotations represent different feedback and at least one of the plurality of annotations is a visual annotation.

12. The system of claim 11, wherein the visual annotation comprises one of emojis, icons, and other visual markers.

13. The system of claim 11, wherein the visual annotation is an individually defined visual annotation.

14. The system of claim 13, further comprise learning and interpreting the individually defined visual annotations over time using machine learning techniques.

15. The system of claim 10, wherein the operations further comprising displaying an annotation panel to select and apply annotations to the content item.

16. The system of claim 10, wherein the annotations are applied to specific sections of the content item to indicate an exact location and nature of a desired change.

17. The system of claim 10, wherein the annotations are converted into text-based calls through a contextual analysis of a surrounding text and the location of the annotation.

18. The system of claim 10, wherein at least two or more of the plurality of annotations are received simultaneously.

19. A computer program product for applying transformations to generative AI content based on visual annotation interpretation, the computer program product comprising:
a set of one or more computer-readable storage media;
program instructions, collectively stored in the set of one or more storage media, for causing a processor set to perform the following computer operations:
receiving a prompt from a user for a generative AI system to create a content item;
providing the prompt to the generative AI system for processing;
receiving the content item from the generative AI system;
displaying the content item to the user;
receiving a plurality of annotations applied by the user to the content item to create an annotated content item;
parsing the annotated content item to identify a type and a location of each of the plurality of annotations;
translating each of the plurality of annotations into a corresponding text-based call that the generative AI system can interpret;
sequentially providing the text-based calls to the generative AI system for processing;
receiving and consolidating responses from the generative AI system to create a revised content item, wherein the revised content item reflects the transformations indicated by the annotations; and
displaying the revised content item to the user.

20. The computer program product of claim 19, wherein the annotations represent different feedback and at least one of the plurality of annotations is a visual annotation.
